(19) United States
(12) Patent Application Publication
(10) Pub. No.: US 2012/0297288 A1
(43) Pub. Date: Nov. 22, 2012

(54) Method and System for Enhancing Web Content

(76) Inventor: Edward Mansouri, Tallahassee, FL (US)

(21) Appl. No.: 13/472,521

(22) Filed: May 16, 2012

Related U.S. Application Data
(60) Provisional application No. 61/486,369, filed on May 16, 2011.

(51) Int. Cl. G06F 17/20

(52) U.S. Cl. 715/234

(57) ABSTRACT

A method for enabling web-based content publishers to securely and selectively enhance their content by injecting discrete, easily transportable, modular applications (i.e., “tools”) into their content. This is accomplished by inserting a single line of HTML code (<SCRIPT> tag) into the content. This enhanced content is sent to a user's web browser and the inserted line of code initiates communications between the user's web browser and a web-server, which then delivers the enhanced content to the end user. Novel encryption techniques are utilized to ensure that the source code for the delivered applications is not revealed during transit, through browser plug-ins, or through browser “view source” functionality.

### PRIORITY OF INVENTION

This application claims priority of invention under 35 USC 119(e) from U.S. Provisional Patent Application Ser. No. 61/486,369, filed on May 16, 2011.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of web based content, and the delivery of that content to end users. More specifically, the present invention relates to a system and method for efficiently and selectively adding functionality to web based content.

2. Description of the Related Art

The internet (a/k/a the worldwide web, WWW, or web), along with computer systems and related technologies, have transformed the way information is delivered, and thereby transformed the way we live and work. This is particularly true in the field of education, where it is now common for students to participate in “virtual” classroom education, where educational content is delivered through computer systems over the internet. Further, these virtual classrooms provide instruction, teacher-student interaction, and classmate interaction through computer systems over the internet.

Content on the internet is typically accessed in a client/server model. A web browser of a client computer system sends a request to access content that is provided by a web server of a server computer system (e.g., by entering a Uniform Resource Locator (“URL”) into the web browser). A URL includes (among other data) a domain portion that identifies the organization controlling requested content and a path portion that indicates the location of the content within a namespace of the organization.

The domain portion of the URL is resolved to a web server under the control of the organization. The path portion of the URL is then sent to the web server. The web server uses the path portion to determine what content is being requested and how to access the requested content. The web server then accesses the requested content and returns the requested content to the web browser. In a web environment, content and requests for content, are frequently transported using Hypertext Transfer Protocol (“HTTP”). Web-based content can be provided in HyperText Markup Language (“HTML”) pages, style sheets, images, scripts, etc.

For example, scripts can be used to perform more complex operations than otherwise allowable using only HTML directives. Generally, scripts are executable code that can be executed at a web server to add content to a page or can be sent down to a web browser for execution at the web browser to add content to a web page. Scripts can be developed in a scripting (programming) language, such as, for example, JavaScript, VBScript, ASP, PHP, Perl, or ASP .Net.

Server-side scripts can be used to obtain data accessible to a web server for inclusion in a corresponding web page or to perform other actions related to returning the corresponding web page. When a web server receives a web browser request for a web page that includes server-side script, the web server passes the server-side script off to an appropriate script engine. The script engine processes the script to perform actions on relevant data and potentially returns portions of the relevant data, for example, represented in corresponding HTML directives. Any portions of relevant data, for example, the representative HTML directives, are then injected into a web page for return to the web browser (along with any client-side scripts).

Client-side scripts are useful for implementing additional behaviors to supplement web browser functionality, such as, for example, to provide richer behavior and user interaction in the web browser without any server interaction. Client-side scripts that request data or additional scripts from the web server or from other web servers are also possible. Client-side scripts can be embedded in a web page or can be included in a separate file. When a client-side script is included in an external file, a web page can include a script reference (e.g., <script type=“text/javascript” src=“hello.js”></script>) referencing the script or such a reference can be subsequently injected into the web page. Client-side scripts and script references can be included in-line in a web page that is sent to a web browser. Thus, as the web browser processes the web page it can access and run embedded client-side scripts as well as external to client-side scripts.

However, the usefulness of the client/server model used on the WWW is highly dependent upon delivering the proper content to a proper user at the proper time. Further, for some users, at some times, additional or enhanced content, or additional or enhanced functionality, may be required to enhance usefulness, for security, or for role differentiation. Accordingly, there is a need for system and method that allows web-based content publishers to easily and efficiently selectively inject functionality into their content regardless of where the content is hosted.

### BRIEF SUMMARY OF THE INVENTION

The present invention provides a simple and efficient system and method enabling web-based content publishers to securely and selectively enhance their content by injecting discrete, easily transportable, modular applications (i.e., “tools”) into their content. This is accomplished by inserting a single line of HTML code (<SCRIPT> tag) into the content. This enhanced content is sent to a user's web browser and the inserted line of code initiates communications between the user's web browser and a web-server, which then delivers the enhanced content to the end user. Novel encryption techniques are utilized to ensure that the source code for the delivered applications is not revealed during transit, through browser plug-ins, or through browser “view source” functionality.

This summary provides, in simplified forms, concepts that are more fully described and detailed below. This summary is not intended to identify key features or essential features of the claimed subject matter, nor is this summary intended to be used as an aid in determining the scope fo the claimed subject matter. Additional features and advantages of the invention will be set forth in the following description, or may be learned by the practice of the invention. The features and advantages of the invention may be realized and obtained by means of the appended claims. These and other features of the present invention will become more fully apparent from the following description and appended claims, or may be learned by the practice of the invention as set described in this application.

In order to describe the manner in which the above-recited and other advantages and features of the invention can be obtained, a more particular description of the invention briefly described above will be rendered by reference to specific embodiments thereof which are discussed herein.

### DETAILED DESCRIPTION OF THE INVENTION

The present invention extends to methods and systems and computer program products for providing a simple and efficient method and system for enabling web-based content publishers to securely and selectively enhance their content by injecting discrete, easily transportable, modular applications into their content. Further, the present invention encompasses a means of delivering HTML/JavaScript code from a web server to a web browser in such a way that the source code is not revealed in transit, via browser plug-ins, or by using a browser's “view source” functionality.

### DEFINITIONS

The following terms, as used in this application, have the definitions stated below:

Advanced Encryption Standard (AES)—a symmetric-key encryption algorithm (see below) that is standardized by the U.S. government.
Asynchronous JavaScript and XML (AJAX)—a group of related technologies used to create web applications that exchange data between clients and servers seamlessly and in the background without user intervention. A good example of AJAX in action is Google Maps, where data is loaded dynamically as a user scrolls to different parts of a map.
Apache 2—a flexible open source web server product that is produced by the Apache Software Foundation, and is widely deployed on many websites across the Internet. Apache 2 is known for its performance and extensibility through various plug-ins that enhance the base web server product.
Application Programming Interface (API)—a particular set of publicly accessible rules and specifications that a software program can follow to access services and resources that are provided by some other program or service that contains the logic to implement desired functionality.
Browser cookies—small pieces of text-based information that are stored by a user's browser that contain information about users, session information, etc.
Blowfish Encryption—a symmetric-key encryption algorithm (see below) designed by Bruce Schneier that is available for use to any developer wishing to make use of it.
Content Injection—the insertion of additional functionality into web based content.
Developer—any person creating injectable applications for the present invention, and making those applications available to Publishers using the present invention.
Developer Key—a unique identifier that Developers use to authenticate their applications to the present invention. Applications that do not provide a valid developer key will not be able to access APIs and Services.
Document Object Model (DOM)—a cross-browser convention for interacting with objects (commonly called “elements”) in web-based documents such as HTML, XHTML, and XML.
Domain Name—an identification label used in various networking contexts that is generally used to map a numerical IP address to a more user friendly format. Domain names are commonly used to indicate possession of a particular resource. For example, the domain name “google.com” is used by Google for all of their services including docs.google.com, images.google.com, etc. Not only are these domain names directing users to particular numerical IP addresses, but they are also telling users that these services are under the control of Google, Inc.
Dublin CORE—a set of metadata elements that provide a foundational group of text elements through which resources can be described and cataloged.
IMS Global Learning Consortium—a global organization dedicated to advancing technology that's mission is to improve education through the development and adoption of open interoperability standards.
jQuery—per jquery.com, “jQuery is a fast and concise JavaScript Library that simplifies HTML document traversing, event handling, animating, and AJAX interactions for rapid web development.”
Learning management system (LMS)—any system that provides a set of features designed to administer, facilitate, track, and report on e-learning.
Learning Tools Interoperability (LTI)—a specification produced by IMS that details how information traditionally stored on an LMS can be passed to a Learning Tool Provider in a such a way that a Learning Tool Provider does not need to create versions of their tools that are specific to any one LMS.
MD5 Hash—creating an MD5 hash involves taking a piece of arbitrary text and compressing it down to a 128-bit (32 character) value. This value acts as a unique identifier for the text that was compressed down. In other words, a piece of text will produce one and only one MD5 value, and no two pieces of text will produce the same MD5 hash value.
Metadata—a somewhat ambiguous term that essentially can be viewed as “descriptive information about data that is somewhat ancillary to the primary purpose of the data”, and is often not “front and center” when looking at data. For example, creation date information on a file may be important information, but it is far less important than the contents of the file itself.
Memcached—a distributed, general purpose system for storing objects in computer hardware's RAM, enabling for faster storage and retrieval of those objects (e.g. versus looking them up in a database).
mod_perl—a plugin for the Apache Web Server that embeds a Perl interpreter into the Apache server so that Perl scripts can respond to incoming requests to the Apache Server.
MySQL—a popular open source relational database management system.
nonce—a random value, often used in cryptography, that is often used to add uniqueness to an encrypted string or used as a message identifier. A characteristic of a nonce is that they are used only one time.
Object Oriented Programming—a computer programming methodology that uses “objects” (data structures that consist of data fields and methods encapsulated with their interactions) to design applications. Applications designed using Object Oriented principles are highly modular and reusable.
Perl—the programming language that is used to script the server side functionality of Octane. Perl code is interpreted rather than compiled, and Perl itself is a very flexible and reliable programming language that has been used in web applications for many years.
Publisher—any person or organization that creates web-based content and delivers it to content consumers (customers or users).
Publisher Key—a unique identifier that publishers use to authenticate themselves and their content to consumers and to the present invention.
Secret Key—similar to a password, a secret key is a string value used in symmetric encryption systems (see below) that is used with an algorithm to scramble plain text from being read. Only users who know the secret key can unscramble encrypted text.
Software Development Kit (SDK)—a set of development tools and libraries that allows for the creation of applications targeted towards a specific software or hardware platform.
Symmetric Encryption—also known as “secret key” encryption, it is a means to protect plain-text messages from unauthorized disclosure. Symmetric-key encryption schemes use an algorithm and a secret key (password) to scramble plain text messages into unintelligible form. The resulting “ciphertext” can be unscrambled by anyone who knows the algorithm and the key used to scramble the original message.

### Components

The present invention relies upon a system architecture comprised of modular and highly scalable components. The primary components include:

1. The Injection Framework (“TIF”)—the TIF is a web server that, upon receipt of a request from a user's web browser, performs content injection. The TIF injects cascading style sheet (CSS) and javascript (JS) code into content. In a preferred embodiment, the TIF runs on Apache 2 web servers, uses Memcached to store data, and uses MySQL to store that data that gets loaded into Memcached. The injected code can be encrypted through encryption schemes as described in this application.

2. The Tools Framework (“TTF”)—the TTF serves as the back end for additional functionality delivered through “tools” injected into web based content.

3. The Tools Data Framework (“TTDF”)—the TTDF provides the database required for storing data required by the present invention.

4. The Memcached Management Apparatus (“TMMA”)—the TMMA manages cached data for the present invention.

5. The Media Foundation (“TMF”)—the TMF serves static content required for tools.

6. The Content Server Product (“TCSP”)—the TCSP can be used to host content with the script tags injected.

A primary feature of the present invention is the simplicity by which web based content can be injected with additional functionality. The general steps of the process are as follows: The first step is a request from an end user for a web page that includes a specific script tag. Next, content is returned to the end user that includes a single line of HTML code (<script type=“text/javascript” src=“http://octane.ucompass.com/PUBLISHER_KEY.js”></script>) that calls the TIF with the Publisher Key for the content. The Publisher Key for the content is sent in the SRC attribute of the <SCRIPT> tag. The TIF then validates the Publisher Key and either returns a display error if validation fails, or returns initial injection code to the end user's browser. This injection code is a JavaScript file (Octaneinit.js) plus any other required global libraries. Next, this injection code requests application code from the TIF. The returned code includes applications that are specific for a particular end user, and these applications then contact and retrieve information from the TTF and the TMF, as required for the particular tools/applications injected.

The present invention is a platform that allows web-based content publishers to inject discrete, easily transportable, and modularized applications into their content regardless of where content is hosted or web browsers in use. The injection of applications is accomplished in such a way that only one line of HTML code needs to be inserted into existing content for activation, or activiation can even be done automatically via the Content Server Product or by making nominal changes to web server configuration. Applications making use of the present invention themselves can be designed to be very lightweight, and conform to practical Object Oriented Programming conventions.

Even though the present invention can be inserted into content with one line of code, publishers can exercise much more granular control over the applications delivered to their content consumers by adding Dublin Core (http://dublincore.org/) metadata tags to their content. The present invention can also inject applications into content based on:
Role, based on those available in the IMS LIS role vocabularies (http://www.imsglobal.org/lti/blti/bltiv1p0/ltiBLTIimgv1p0.html#_Toc261271984) or as otherwise defined
Browser cookie values set by the publishing server
Path to the content on the server
Patterns in certain values related to content such as cookie values
Custom metadata tags defined by publishers
Geolocation

These options give content publishers the ability to exercise very granular control over enabled application delivery. As an example, a publisher could include a periodic table application in Chemistry courses only, providing a valuable resource to students without bogging down other Math, English, etc. students with something that they do not need.

The present invention can be used anywhere that content is published. Using the present invention, content publishers can deliver a “liquid” LMS experience to their content consumers that is focused primarily on content, delivering tools their users need based on what they are viewing and their level of involvement with the content (role). This changes the traditional paradigm where content is forced into an LMS; rather, the present invention brings the LMS to the content.

Through powerful developer Software Development Kits (SDKs) and Application Programming Interfaces (APIs), developers can create applications that can be added to the library of applications that publishers can add to their content.

The architecture is comprised of several modular and highly scalable components, ensuring maximum flexibility with regards to how it is deployed. However, from a user's perspective, all they will see is a tool icon or some functionality injected into the page, with all of the “back end” complexity completely invisible to them.

Each component within the architecture acts as its own standalone entity; components are tuned to perform a specific task, and each component can be easily scaled independently of the other components that make up the present invention.

To increase performance, the present invention uses a layered caching system for storing data (which, again, is managed by the TMMA). First, data can be stored in mod_perl global variables. If a value that a particular request is looking for is not stored in the list of mod_perl global variables, the next step is to look for the value in Memcached. Finally, if a value is not found in Memcached, it will be retrieved from a service that will generate it (database, process, etc.), where it is usually then stored in Octane's caching system.

### Component Descriptions

A more detailed description of each component comprising the present invention's architecture is as follows:

The purpose of the TIF is to inject CSS and JS code into content. This framework runs on Apache 2 web servers, uses Memcached to store data, and uses MySQL to store the data that gets loaded into Memcached. The code that is injected into content can be protected from disclosure using one of two different encryption schemes (“Strong” or “Weak” based on the preferences of the developer.

The TIF is activated by a single line of HTML (a SCRIPT tag) in a content publisher's code. This line of code can be either manually inserted into content by a particular publisher, automatically inserted into content on the fly if a publisher is making use of the TCSP, or by making simple configuration changes to the web server that is serving content. The line of code that is inserted into a particular publisher's content looks like the following:

<SCRIPT TYPE=“text/javascript”
SRC=“http://octane.ucompass.com/PUBLISHER_KEY”></SCRIPT>

Where the value of PUBLISHER_KEY is an 8 character value (comprised of numbers and lower case letters) that is used to uniquely identify each publisher using the present invention. Publisher keys are set by Administrators.

Once the TIF receives a request from a client that is viewing a particular publisher's content, several steps take place.

The following steps more carefully detail how the TIF works:
1. The TIF processes the request through an Apache PerlTransHandler. This PerlTransHandler essentially takes the publisher key from the URL that is sent to the TIF (http://octane.ucompass.com/PUBLISHER_KEY), and ensures it's in the proper format (8 characters of numbers and lower case letters). The verification that the publisher key is in the correct format is handled by a custom Perl library (Octane::Server::Register).
2. If the publisher key is found to be in the correct format, the TIF directs the request to /register on the server, which contains a custom Perl library (Octane::Server::Injection) that does further validation on the publisher key. This validation involves ensuring that the publisher key submitted belongs to an actual publisher with permission. An alert is thrown if the key is invalid. Note that for performance reasons, once a publisher key is validated in this manner, it is added to a cached list of valid keys.
3. Once the publisher key is found to be valid, an additional validation step is undertaken by the TIF. Since publishers can set restrictions on domain names that can access their content, the TIF will ensure that the publisher key is being submitted by a domain name that should have access to the content. Users who are trying to access content from an unapproved domain name will have a message displayed on their pages that their domain name isn't valid for the publisher key they are using.
4. If everything with the publisher key checks out ok, then the TIF starts the process of injection. In the Octane::Server::Injection Perl package, there is a method called printInitCode( ) that loads up a file named OctaneInit.js, which contains JavaScript code that starts the process of injecting content with tools. For performance reasons, OctaneInit.js is cached using the hierarchy described in the beginning of this section, only instead of the “bottom” layer being a database, it is the server's file system.
5. Once the printInitCode( ) method loads the OctaneInit.js file, it runs the JavaScript code through a Perl package called Octane::Server::Utils::javascriptCleaner that compresses the JavaScript code, and runs it through an obfuscator to make it difficult to read and reverse engineer.
6. The printInitCode( ) method then will make a determination if code protection is enabled.

If it is enabled, the method will retrieve a one-time gatekeeper key that is valid for 10 seconds and is cached on the system. Note that “Weak” code protection uses the AES encryption algorithm, and “Strong” code protections uses the Blowfish encryption algorithm. Other code protection values of “None” and “Debug” (used for testing) exist, which employ no code protection
7. Then, the printInitCode( ) method then gets list of the roles a client has (can come from an LMS via LTI or some other process), and encrypts strings that contain each role that the user has.
8. Finally, the printInitCode( ) method makes some “on the fly” substitutions into the OctaneInit.js file, including the gatekeeper key, code protection scheme, roles, and the URL that is hosting the Octane Injection Framework. Once the substitution is made, the OctaneInit.js code is returned and sent to the content consumer's (client's) web browser.
   With OctaneInit.js returned to the client, a sequence of events begins that performs the injection of tools into a client's browser session.
1. The OctaneInit.js contains a class called_OCORE_(as well as some jQuery code which ensures that the browser is ready to have Octane do its work), which is instantiated immediately into a variable named $O. As part of instantiation, the inject( ) method of the _OCORE_ class is called. Note that _OCORE_ also contains several helper shortcuts for accessing DOM elements on a page.
2. The inject( )method of the OCORE class calls one of two other methods based on the code protection mechanism in place.
   If code protection is set to Weak or None, an AJAX request is made to the TIF that will retrieve the JavaScript and CSS code that is needed to power the tools that a particular user has access to. The AJAX request basic passes some basic information to the TIF like domain, publisher key, code protection scheme, a nonce value (to act as a message identifier), protocol (http:// or https://), and the decryption gatekeeper key discussed in step 6 above. The AJAX request also contains important information needed to perform the injection such as path of the page, cookies, and META tags.
   If code protection is set to Strong, the inject( )method will embed an invisible compiled .SWF (Adobe Flash) file, and pass the encrypted gatekeeper key into the .SWF file so it can be used. The encrypted gatekeeper key is decrypted by the .SWF file, and re-encrypted using another key. The SWF file loads up other information about the page, just as in the Weak or None code protection schemes (cookies, domain, the path of the resource, META tags, nonce value, etc.) and posts all of the information back to the TIF (octane.ucompass.com).
3. The TIF processes the request through a special Apache handler that directs the request (regardless of the code protection scheme in use) to a specified location, where the inject( )method is invoked in the aforementioned Injection.pm.
4. Before the inject( )method in Injection.pm starts the process of injection, it will first gather in all of the parameters that were posted to it, and do some basic gate keeping.
   a. The first step in the gate keeping process contained in the inject( ) method is that a check is made against the nonce value that's passed into the TIF. If the nonce is not currently being used, the system then knows that the request is not a duplicate of a request that's all ready being processed (a security convention that prevents replaying of requests).
   b. Another simple check is to make sure that the data was posted to the TIF using an HTTP POST method.
   c. Once the nonce and HTTP POST tests pass, the TIF then does a check to make sure that the gatekeeper key is valid by comparing the value that was passed to the TIF with the one that was cached. Again, in a Strong code protection scheme, the gatekeeper key will have been re-encrypted with .SWF file with a different key before it was sent back to the TIF. Therefore, it has to be decrypted by the TIF before it is validated.
   d. Lastly, a test is run to ensure that the domain that is passed to the TIF is registered with the publisher key passed that was passed to the TIF.
5. Once all of the basic gate keeping checks have passed, the TIF gathers up all of the tool code (including any relevant libraries required by the tool code) that the client should have access to. Setting which tools belong to which resources and who can access them is set using a resource portal. Managing libraries needed to various tools is also done through this portal. The code itself is stored using the TIF's caching mechanism.
6. When all of the code (which will be CSS and JavaScript code) for the tools the client should have access to is retrieved, it is passed to the printCode method of Injection.pm. The printCode method runs the code passed to it through a JavaScript compressor and obfuscator (similar to step 5 in the previous set of steps).
7. Next, the printCode( )method will determine if the code needs to be encrypted using either the “Weak” or “Strong” code protection schemes before it is returned to the client's web browser.
   If code protection is set to Weak, the code is encrypted using the AES encryption algorithm using the key that was used to encrypt the gatekeeper key in step 6 of the previous set of steps.
   If code protection is set to Strong, the code is encrypted using the Blowfish encryption algorithm using the key that was used to encrypt the gatekeeper key in step 6 of the previous set of steps. Note that Strong code protection requires a user to have ADOBE® Flash installed on their browser.
8. The printCode( )method then returns the code to the client over the Apache Web Server's Deflate module (for compression) according to the following rules:
   a. If code protection is set to None, the code processed using a method in OctaneInit.js (which made the AJAX call to the TIF) called handleCode( ). This method runs the returned code through a built in JavaScript function called eval( ) that activates the Octane Tool code.
   b. If code protection is set to Weak, the code processed using a method in OctaneInit.js (which made the AJAX call to the OIF) called handleCode( ). This method will decrypt the encrypted code returned from the OIF, and runs the decrypted code through a built in JavaScript function called eval( ) that activates the tool code.
   c. If code protection is set to Strong, the code processed using the .SWF file that called the TIF. The .SWF file will decrypt the encrypted code returned from the TIF, and runs the decrypted code through a built in JavaScript function called eval( ) that activates the Octane Tool code.
9. The injected tools are now active for the user.
   This process, while complex, is accomplished in very short period of time (a couple of seconds or less), and ensures not only the security of the system itself, but can protect tool code from being divulged when the Weak or Strong code protection schemes are activated by a tool developer.

### The Tools Framework (TTF)

Many applications need to leverage server-side logic and\or data from a database in order to deliver rich and meaningful experiences to users. The purpose of the TTF is to provide a robust and highly scalable back-end logic framework for tools to be utilized with the present invention. The TTF leverages the Apache Web Server, Perl, as well as a proprietary gateway engine that manages and processes requests for back end functionality.

The proprietary gateway the TTF uses is built upon a foundation of standard Perl modules and proprietary Perl packages developed by the inventor, and is designed to accept requests in a number of standard formats including XML (eXtensible Markup Language), AMF (ActionScript Message Format), YAML (Yet Another Markup Language), JSON (JavaScript Object Notation), SOAP (Simple Object Access Protocol), Perl Structures, and Raw HTTP format. This allows developers using the TTF flexibility in how they transmit data back and forth between web browsers and servers.

Access to the TTF is maintained through the use of developer keys that are passed to the gateway along with any request. This information is maintained in two database tables (“developer_keys” and “developer_keys_metadata”) that exist in an TTF database called “Internal”. When a request is passed to the TTF, a lookup is made to determine which database is associated with a particular developer key, and that database is then used to process the rest of the request.

Regardless of which database the TTF ends up using for the request, there will always be a table in the database named “rpc_methods” that maintains a list of API methods that a particular developer key has access to. API methods are used to perform various actions such as accessing a database, performing some server-side logic, processing data, etc. The potential actions that can be performed by API methods are infinite; the possibilities are only limited by the imagination of the developer.

API methods are made accessible through the creation of a Perl class that contains a set of methods that clients can access. Once the Perl class is created, a record is then added to the “rpc_methods” database table in the database that is associated with a particular developer key. This record contains the mapping relationship between API methods and Perl class(es) on the server.

When a request is made to the TTF gateway, the following sequence of events occurs:
1. A Perl class called “Generic.pm” is called. This class gets the format that the data being passed into the gateway is in, and then instantiates the appropriate formatter class (AMF.pm, XML.pm, etc. [each format the gateway can accept has its own class]).
2. The formatter class that was chosen in the previous step will then call a method called “deserialize” that reads in all of data passed to the gateway, and then formats the data into Perl data structures so that it can be processed.
3. A determination is then made if the request API method is available (again, this information is in the “rpc_methods” table, and this information will be cached upon success). If the method is available, the data that was sent to the gateway is then passed to the requested API method, where it is processed and returned.
4. The data returned from the API method is then serialized back into the input format and returned back to the client who requested it.
   This process is relatively straightforward, but note that there can be a lot of complexity in the API methods being called and the different data formats (AMF, JSON, XML, etc.). The OTF, however, abstracts a lot of this inherent complexity away from the developer, providing a consistent and flexible format for tools to perform server side logic.

### The Tools Data Framework (TTDF)

The purpose of the TTDF is to provide a reliable and scalable database framework for tools. The database that powers the TTDF is the ubiquitous open source MySQL database server, and the environment operates in a master\slave relationship for maximum performance when applications are under heavy load from users.

The best way to explain the TTDF is to look at a simple example of an actual application that uses it—the Lesson Ratings tool. The goal of this tool is to provide content consumers a means by which they can rate the quality of the content they are viewing. In order to perform its job, the Lesson Ratings tool needs to store and access several important pieces of information:
A list of courses where the ratings tool should appear (as well as some metadata about the course).
A list of resources (pages) in a specific course where the ratings tool should appear (as well as some metadata about the resource that contains the ratings tool).
A list of ratings, containing the user who gave a rating (to prevent duplicate ratings), the resource that had the Lesson ratings tool embedded on it, as well as the rating the user assigned a particular lesson.
   All of the data needed to power this particular tool is stored in database tables on the TTDF, where it can be read, modified, deleted, and exported by various Perl scripts that manage the Lesson Ratings data from the TTF. Thus, it could be said that the TTF will almost always have a heavy dependency on the TTDF when a particular tools stores and retrieves information in order to function.

### The Memcached Management Apparatus (TMMA)

Memcached is an important part of the present invention, allowing the platform to deliver very fast performance under heavy load.

The TMMA is how the present invention manages data that is going into and out of Memcached. There are two primary Perl packages that control access to Memcached:

Octane::Common::Utils sets up access to Memcached for the TIF.

Octane::Tools::Utils sets up access to Memcached for the TTF

Both files have a global array variable named @memCachedServers that contains the list of Memcached servers each framework is able to use.
Two very important Perl packages to the TMMA are:
Octane:: Common::Queries, which contains a static mapping of database queries used in the present invention. Each query is indexed by Perl package name and the method that needs the query, plus an index value of the query in a particular method. So, for example, the first SQL query needed in the _getCookieFeatures method of the Octane::Server::Generator::Features package will have an index of Octane::Server::Generator::Features::_getCookieFeatures,0.
Octane::Common::TMMA, which contains the actual code that makes queries (if necessary), and manages the data in Memcached.
   When a Perl package needs to retrieve\manage stored data, the request is processed through the TMMA using a method of the TMMA.pm class called getQuery( ). The getQuery method first accepts the parameters (Package+method, index) that locate the query in Octane::Common::Queries. Once the correct query is found, it is then returned. An additional parameter is also passed into the getQuery method that acts as a “command” parameter, and corresponds to one of four different options (any value passed that is greater than ‘3’ will automatically be treated as if it were a ‘1’—see below):
1. Passing a 0 into the getQuery method means that the data should be retrieved straight from the database (MySQL), bypassing Memcached entirely.
2. Passing a 1 into the getQuery method means that the method should first check to see if the data for the query is stored in Memcached, and if it is, to return the data. If the data is not in Memcached, then the query will be made against the database. Note that the results of database queries are stored in Memcached in “key\value” format, where the “key” is an MD5 Hash of the query being performed, and the “value” is the result of performing the database query. Data stored in Memcached is always for a set period of time (calculated in seconds) to clear out data that is not currently being used, thus making room for other queries.
3. Passing a 2 into the getQuery method means that the method will perform the query against the database, whether data is stored in Memcached or not, and then update the data in Memcached once the data is retrieved.
4. Passing a 3 into the getQuery method means that the method should delete the key-value data that is stored in Memcached for a particular query.
   Finally, there is a method in the Octane::Common::OMMA Perl package called rebuild( ) which will completely flush everything in Memcached, rebuild all of the queries, and store everything back in Memcached. A call to this method must be made judiciously, as the process of rebuilding all of the queries puts a heavy load on the MySQL server for a period of time.

### The Media Foundation (TMF)

The purpose of the TMF is to serve static (GIF, JPG, PNG, SWF, XML, etc.) tool content developed for delivery to end users. The TMF runs on Apache 2 web servers, serves only static content, and makes use of an Apache 2 module called mod_deflate that compresses content on the fly before it is delivered to end users to ensure fast transmission of content. The TMF is very simple in principle. If a tool needs to access a resource on the TMF, it simply references the correct URL on a designated web address. So, for example, if a tool needs a file called resource.gif on the TMF in order to display functionality to users, the tool will simply call up the resource it needs at a designated web address.

Serving static content in this manner allows the system to optimize its other frameworks for tasks like performing the code injection (in the case of the TIF) and performing server-side program logic (in the case of the TTF), thus providing for maximum scalability and adherence to web performance best practices.

### The Content Server Product (TCSP)

The TCSP serves two primary purposes in the present invention's architecture:
1. Providing a reliable and scalable architecture for publishers to host the content that they wish to allow customers to access.
2. Injecting tags into content placed on the server automatically on the fly, making no changes at all to the source content, enabling the content to take advantage of the present invention's rich feature set.
   Access to the TCSP is established through a portal.

The TCSP runs on the Apache 2 web server platform, with a custom file system developed by the inventor to manage content (via FTP and the portal). It is a highly scalable architecture designed for serving content to the customers of publishers and allowing publishers to manage their content effectively.

Even though the present invention works very effectively when a publisher chooses to host content themselves, the publisher who chooses to leverage the TCSP gains not only access to very reliable and scalable hosting, but also several value-added tools for managing injections. For instance, the TCSP can automatically facilitate the injection of the JavaScript code that is necessary to call up the TIF without a publisher needing to modify all of their content or configure web servers themselves, saving valuable time and resources, and enabling a publisher to get up to speed using the present invention in very little time at all. Using the portal, publishers can also manage the injections of their own metadata tags in their content “on the fly” using a variety of means without having to modify any of their content. In short, the TCSP gives publishers maximum flexibility when it comes to leveraging the present invention.

The way content is injected with script tags on the fly is very simple. A directive is added to the Apache 2 Web Server that passes all content through a Perl script (Apache::OutputChain Packages::PilotFish::OctaneFilter) that inserts the tags that need to be inserted into a page. When that is complete, the page is served up to users with the new tags inserted.

### The Portal (TP)

The TP is a “front-end” interface for managing several aspects of the framework, providing a means to tie several of the disparate components of the present invention framework together.

The P is designed to be used by three different constituencies:

Administrators

Tool Developers

Publishers injecting Tools into their content

Each one of these constituencies is represented on the top menu bar of the TP as described below:
Administrators will see an “Admin” menu when they log into the TP. This menu allows administrators to perform three primary functions:
   1. Adding and managing publishers, as well as the users who are associated with a particular publisher. Examples of settings that Administrators can set for publishers include giving a publisher access to the TCSP (and setting the FTP root to the server if a publisher should have access), setting the URL that is used to access tools the publisher has access to, making a publisher active\inactive, and setting the type of code protection the publisher employs. Publisher key information is also available from the publisher management interface.
   2. Adding and managing development companies using the present invention, as well as the users who are associated with a particular development company. The interface for managing developers is very simple, allowing an administrator to activate\inactivate a development company, as well as retrieve developer key information for the company (this is not to be confused with individual developer keys).
   3. Managing LTI callers for development companies, including making a caller active\inactive, and viewing information that is needed to make LTI calls to a particular development company's Octane tools.
Development companies using the TP will see a menu bar with their name on it. This menu allows development companies to perform three primary functions:
   1. Manage JavaScript libraries (and their JavaScript and Cascading Style Sheet dependencies) that are needed for tools built by the development company.
   2. Managing tools created by the development company, including setting any library dependencies that a particular tool may have (see #1), as well as which publishers should have access to each tool produced by the development company. Also, if a tool has a customer relations URL (for viewing things like tool reporting information), it is assigned here as well.
   3. Managing users who work for the development company.
Publishers using the TP will see a menu bar with their name on it. For example, a publisher named ABC Publishing, Inc. will see a menu bar across the TP called “ABC Publishing, Inc.”. This menu allows publishers to perform five primary functions:
   1. Managing the customers of their content and view their customer keys.
   2. Managing the sites that belong to a customer of publisher content.
   3. Managing the injections that will be performed on each customer site.
   4. Managing users who work for the publisher.
   5. Creating and managing sites on the TCSP (if a publisher has access).
      In addition to a menu bar, development companies have access to file systems to help manage their tools. This access is represented as an icon on the TP desktop with the development company's name on it (similar to the menu bar). When clicked on, a file system opens that allows the development company to manage the JavaScript and CSS files that power their tools (note that these are also the only types of files they will be able to place on this file system—all other file types are deleted), as well as specify which files are libraries and which ones are actually tools. Finally, when files are made into libraries or tools, any dependencies that the file has in order to function properly can be set.

Publishers using the TCSP will also have access to file system where they can manage their content as if they were using a file manager on their desktop computer (copy, cut, paste, move, delete, etc.). Access to their file system is represented as an icon on the TP desktop with the publisher's name on it.

The TP also has a “Connect to Your Desktop Volumes” feature that allows a user to open files on their local hard drive (using a combination of Adobe Flash and AIR technology) for the purposes of copying\managing files between Octane and their local desktop easily. This feature is available to both development companies and publishers (provided they are using the TCSP).

### Other Management Tools

In an architecture as diverse and scalable as the present invention, it is important to have a set of tools in place that can help keep all of the different environments in sync with one another. The inventor has developed and deployed a set of tools designed to manage deployed code in all of the different frameworks. These tools are a set of simple Perl scripts. Two important scripts are as follows:
upload.pl, which will sync code that is stored on a developer's local machine to the live production environment.
download.pl, which will sync production-deployed code to a developer's local machine.
   Parameters such as “omf”, “otf”, etc. can be passed to these scripts that will only sync code that belongs to a particular framework. So, for example, the command “upload.pl otf” will sync all of a developer's locally stored Tools Framework (TTF) code to the live production tools environment.

Another important Perl script used for managing the present invention is called octanesync.pl. Various values can be passed to this script that will perform different actions. For example:
Passing a “1” to this script restarts the Apache Web server on the TTF and the TIF.
Other arguments such as “client”, “server”, and “common” can be passed to the script that control which portions of the overall framework are updated can be passed as well

Having described my invention, I claim:

1. A method for enhancing web based content comprising:
a. modifying said content by inserting a script tag into said content;
b. upon the request of a user, delivering said modified content to a user's browser;
c. instigating, via said script tag, a communication from said user's browser to a server;
d. validating, by said server, information contained within said script tag and information unique to said user;
e. upon validation, transmitting application code from said server to said user's browser; and
f. customizing said application code to meet a set of requirements unique to said user.

2. The method of claim 1 wherein said application code constitutes at least one discrete application to be embedded within said content.

3. The method of claim 1 wherein said application code is encrypted.
